(19) United States
(12) Patent Application Publication
(10) Pub. No.: US 2023/0080391 A1
(43) Pub. Date: Mar. 16, 2023

(54) DENTAL ANCHORING SYSTEM FOR ANCHORING A CARRIER ELEMENT TO AN ANCHORING ELEMENT

(71) Applicant: Johannes Scherer, Kissing (DE)

(72) Inventor: Johannes Scherer, Kissing (DE)

(21) Appl. No.: 17/958,399

(22) Filed: Oct. 2, 2022

Related U.S. Application Data
(63) Continuation of application No. PCT/DE2021/000058, filed on Mar. 31, 2021.

(30) Foreign Application Priority Data
Apr. 24, 2020 (DE) DE102020002480.7

(51) Int. Cl. A61C 8/00

(52) U.S. Cl. CPC A61C 8/0053; A61C 8/0068

(57) ABSTRACT

A dental anchoring system configured to anchor a carrier element at an anchoring element, the dental anchoring system including the carrier element; the anchoring element; and a fastening bolt, wherein the anchoring element includes a receiving section configured to receive the carrier element and a threaded bore, wherein the carrier element is configured to directly or indirectly attach a dental superstructure element or a dental prosthesis and wherein the carrier element includes a support section configured to be supported at the receiving section of the anchoring element, wherein the carrier element is attachable at the anchoring element by a first anchoring type using the fastening bolt by receiving the support section of the carrier element at the receiving section of the anchoring element and threading the fastening bolt into the threaded bore of the anchoring element.

### RELATED APPLICATIONS

This application is a continuation of International application PCT/DE2021/000058 filed on Mar. 31, 2021 that claims priority from German patent application DE 10 2020 002 480.7 filed on Apr. 24, 2020, both of which are incorporated in their entirety by this reference.

### FIELD OF THE INVENTION

The instant invention relates to a dental anchoring system for anchoring a carrier element at an anchoring element according to the preamble of claims 1 and 18.

### BACKGROUND OF THE INVENTION

A dental anchoring system is known e.g. from DE 10 2015 100 117 B4. This document shows an abutment with an inner cone that is placed onto an outer cone of an implant and is supported thereon by a fastening bolt. Thereafter, a dental prosthesis is attached at the abutment. The threaded connection, however, can only be disengaged by a dentist in order to remove the abutment. However, dental anchoring systems with bolted components are often demanded by patients because the patient then has the feeling of having firmly planted teeth of his own.

DE 10 2016 118 668 A1 discloses another dental anchoring system with a disengageable positive form locking interlocking connection between a cap that supports the dental prosthesis and an implant. This disengageable interlocking connection facilitates removing the cap with the dental prosthesis by the patient or the dentist so that cleaning the cap including the dental prosthesis and exposed surfaces of the implants is possible in a simple manner, however, the patient does not get the feeling of a firmly planted dental prosthesis like in the prior art cited supra.

### BRIEF SUMMARY OF THE INVENTION

Thus, it is an object of the invention to provide a dental anchoring with more flexibility.

The object is achieved by a dental anchoring system according to claim 1 and claim 18.

The core idea of the invention is initially providing the patient with a dental anchoring system using a first anchoring type where the carrier element is attached at the anchoring element using an fastening bolt so that the patient gets the feeling of firmly planted teeth.

However, when the patient is not able to clean his teeth any more with increasing age or due to his physical condition e.g. requiring nursing home care or when a repair is required, then the dental anchoring system can be transformed from a first anchoring type into a second anchoring type without great complexity.

Using the second anchoring type of the dental anchoring system the push button or interlocking connection facilitates easy disengagement of the carrier element from the anchoring element e.g. by the patient himself or by health care personnel without having to resort to a dentist for this purpose. When the patient reaches a higher age and requires nursing home care, the components of dental implants that are connected with one another by threaded connections cannot be disengaged and cleaned by the patient or by nursing home personnel which can cause a loss of the dental implants.

The inventor has recognized the long-term problem recited supra and developed the dental anchoring system accordingly. The invention provides a dental anchoring system which provides a feeling of firmly planted teeth to the patient using the first anchoring type. However, the dental anchoring system can be disassembled and cleaned by the patient himself or by nursing home personnel without great complexity when the dental anchoring system has been reconfigured from the first anchoring type into the second anchoring type. Additionally, the dental anchoring system according to the invention can also be repaired by the dentist more easily.

A first aspect of the invention relates to a dental anchoring system configured to anchor a carrier element at an anchoring element, the dental anchoring system comprising the carrier element, the anchoring element and a fastening bolt wherein the anchoring element includes a receiving section configured to receive the carrier element and a threaded bore, wherein the carrier element is configured in particular at an outside surface of the carrier element to directly or indirectly attach at a dental superstructure, in particular a dental prosthesis, and wherein the carrier element includes a support section at an inner surface of the carrier element that is supported at the receiving section of the carrier element wherein the carrier element is attachable at the anchoring element by a first anchoring type using the fastening bolt, wherein the carrier element is received at the support section of the carrier element by the receiving section and the fastening bolt is threaded into the threaded bore hole of the anchoring element.

Direct or indirect attachment of the dental superstructure at the carrier element means that the dental superstructure, e.g. a dental prosthesis is directly connected or connectable with the carrier element or that at least one additional element of the dental anchoring system can be arranged between the dental superstructure and the carrier element.

According to the first embodiment of the invention, the carrier element is attachable at the anchoring element optionally also by a second anchoring type without using the fastening bolt by providing a positive form locking connection between an outer part and an inner part that is disengageable multiple times without destruction wherein the inner part is interlockable in the outer part by a press button or interlocking connection elastically deforming the inner part and/or the outer part in particular without relative rotation and wherein the outer part is provided in particular supported or configured at the anchoring element and the inner part is provided and in particular supported or configured at the carrier element, or the inner part is provided and in particular supported or configured at the anchoring element and the outer part is configured and in particular supported or configured at the carrier element and the carrier element is received with a support section of the carrier element at the receiving section of the anchoring element by positive interlocking of the inner part and the outer part so that the carrier element is removably supported at the anchoring element, wherein the carrier element is pullable from the anchoring element by unlocking the inner part from the outer part without destruction for disengaging the second anchoring type.

Put differently the dental anchoring system according to the first embodiment of the invention uses a second anchoring type in addition to the first anchoring type from the beginning without using the fastening bolt wherein a reassembly of the dental anchoring system from the first anchoring type to the second anchoring type and from the second anchoring to the first anchoring type is optionally possible and provided without having to change the geometry/shape of parts, assemblies or components (anchoring element, carrier element) used for the first anchoring type and the second anchoring type.

“Supported” means that the inner part and/or the outer part is a separate part with reference to the anchoring element and the carrier element, and is thereafter arranged and supported at the anchoring element and the carrier element. “Configured” means that the inner part or the outer part is an integral part of the anchoring element or of the carrier element. This can be the case in particular also right from the beginning, this means already in the condition of the dental anchoring system in the first connection type.

“In particular” without rotation means that no relative rotation between the carrier element and the anchoring element occurs during interlocking and unlocking of the press button or interlocking connection.

A disengageable and form locking connection between the outer portion and the inner part configured as a press button connection or interlocking connection includes any connection between an outer part and an inner part that can be brought into form locking engagement and removed out of the form locking engagement without causing any destruction. Among these are in addition to press button connections in particular interlocking connections where elastic interlocking elements like e.g. elastic interlocking arms or interlocking tongues interlock in recesses or cut outs of the respective partner (carrier element or anchoring element) of the interlocking connection or geometries of the respective partner (carrier element or anchoring element) of the interlocking connection that positively interlock behind elastic interlocking elements like, e.g. interlocking edges.

The terms outer part and inner part do not have to be interpreted in a narrow sense so that the inner part has to be completely received in the outer part when the press button connection or interlocking connection has been established. Rather the terms outer part and inner part have to be interpreted in a wider sense so that only components or sections of the inner part are arranged within the outer part or only components or sections of the outer part envelop or enclose the inner part when the press button or interlocking connection has been established.

Thus, the outer part can have an undercut cross section relative to the cross section of the inner part so that the inner part is insertable or interlockable into the outer part while elastically deforming the inner part or the outer part due to an internal force impact. Consequently, the inner part can be stiffer than the outer part or the outer part can be stiffer than the inner part. Advantageously, a material pairing is used where the outer part is made from a resilient synthetic material and the inner part is made from a stiffer metal material or vice versa. Various forms and material pairings can be used that implement a disengageable positively form locking connection between an inner part and an outer part. For example the outer part can be formed by a sleeve that is provided with at least one slot in order to facilitate an elastic expansion of the outer part when the inner part is inserted into the outer part.

Therefore, the dental anchoring system is reconfigurable from the first anchoring type to the second anchoring type in particular by loosening the fastening bolt, pulling the carrier element from the anchoring element and arranging the inner part at the anchoring element in case the inner part is not already arranged or configured at the anchoring element and thereafter interlocking the inner part into the outer part without destroying the inner part or the outer part. Thereafter the carrier element is joined with the anchoring element and advantageously the carrier element is connected with the outer component. Alternatively, the carrier element can be connected with the outer part right from the beginning, this means already in the condition of the dental anchoring system in the first anchoring type.

Furthermore, the dental anchoring system is reconfigurable from the second anchoring type to the first anchoring type in particular by pulling the carrier element from the anchoring element, optionally removing the inner part and/or the outer part and then joining the carrier element with the anchoring element and threading the fastening bolt into the threaded bore hole of the anchoring element. This is possible since the threaded bore hole is still provided in the anchoring element.

The invention therefore advantageously combines the dental anchoring system with the first anchoring type (bolted down) and the dental anchoring system described supra with the second anchoring type (disengageable press button connection or interlocking connection) with one another. In particular the invention facilitates reconfiguring dental anchoring systems with the first anchoring type (firmly bolted down) already provided in patients into the dental anchoring systems with the second anchoring type (disengageable press button or interlocking connection) without requiring a change to the anchoring element or the carrier element. The dental prosthesis supported by the carrier element directly or indirectly can be kept without change.

Thus, the carrier element can form an apically open cavity with an inner surface of the carrier element wherein the shaft of the fastening bolt at least partially extends through this cavity in particular coaxially when using the first anchoring type. This cavity can be configured so that an arrangement of the inner part and/or the outer part in the cavity is possible in particular after removing the fastening bolt or that the inner part and/or the outer part is already initially arranged in the cavity so that the shaft of the fastening bolt can be run through the cavity at least partially.

Reconfiguring from the first anchoring type to the second anchoring type is then possible in a simple manner for this embodiment because the cavity of the carrier element is configured after removing the fastening bolt so that a subsequent arrangement of the inner part and/or the outer part is possible in the cavity or because the inner part or the outer part was arranged in the cavity already at the beginning, this means in the condition of the dental anchoring system in the first anchoring type.

Thus, the invention facilitates initially fabricating a dental anchoring system with the first anchoring type (firmly bolted down) which facilitates a reconfiguration to a dental anchoring system with the second anchoring type (press button or interlocking connection that is disengageable any time) by adding individual components like the inner part and/or the outer part and by removing the fastening bolt without requiring changes to the anchoring element or the carrier element.

According to an advantageous embodiment the inner part or the outer part can be configured at a coronal end of a bolt that differs from the fastening bolt, wherein the bolt is threadable into the threaded bore hole of the anchoring element with an apical end of the bolt that is used in the second anchoring type instead of the fastening bolt. Then the preexisting threaded bore hole of the anchoring element, which would be useless without using the fastening bolt when using the second anchoring type, is used for supporting the bolt which then supports the outer part or the inner part or at which the outer part or the inner part is arranged or integrally provided in one piece. The outer part or the inner part forms then forms a type of bolt head for the bolt. In order to reconfigure from the first anchoring type to the second anchoring type, the attachment screw is removed from the threaded bore hole and replaced by the bolt with the outer part or the inner part at the coronal end which is then also threaded into the threaded bore hole.

The inner part and the outer part can be separate parts that are attachable at the carrier element and at the anchoring element. The inner part and/or the outer part can also be configured rotation symmetrical. The inner part and the outer part can also be integrally configured at the anchoring element in particular in a portion of the receiving section. The inner part or the outer part can also be integrally provided at the carrier element. A separate inner part or a separate outer part can then be omitted.

According to an advantageous embodiment the outer part can be configured at least partially spherical and the inner part can be configured at least partially with a complementary spherical shape so that the outer part and the inner part are pivotable relative to each other into a plurality of relative pivot positions when the inner part is interlocked in the outer part.

The inner part can include an outer spherical layer surface or spherical segment surface and the outer part can include an inner spherical layer surface or spherical segment surface that is complement to the outer spherical layer surface or spherical segment surface. The outer part can be formed e.g. by a slotted sleeve whose inner surface then includes a spherical surface section.

According to an advantageous embodiment a defined relative pivot position of the plurality of relative pivot positions can be provided where a direction of a center axis of the outer part and/or a direction of the center axis of the inner part corresponds to an assembly and/or disassembly direction of the carrier element with respect to the anchoring element.

In the defined relative pivot position the center axis of the outer part and the center axis of the inner part can be coaxial or non-coaxial.

This embodiment is suitable when the dental anchoring system is used for several teeth including prosthetics and implants where the implant axes of implants that are not placed in parallel are oriented in different directions and then it is advantageous when the center axis of the outer part and/or of the inner part is alignable at an angle relative to the anchoring element and/or the carrier element so that no wedging or damages occur at the inner part or the outer part during assembly or disassembly.

Thus, an alignment element can be provided and the outer part and/or the inner part can include an engagement section configured to engage the alignment element so that the outer part and the inner part are pivotable into the defined relative pivot position by engagement of the alignment element at the engagement section and by the subsequent movement of the alignment element.

Thus, the alignment element can be configured in particular rod shaped and engage the engagement section configured as an opening with one end of the alignment element so that a movement of the alignment element imparts a torque upon the inner part or the outer part so that it is pivoted relative to the carrier element or the anchoring element.

The outer part and the inner part can also form a double joint in combination or components of a double joint so that

a) a first joint of the double joint enables a relative pivoting of the outer part and the inner part about a first joint axis in a first pivot plane, and

b) a second joint of the double joint facilitates a relative pivoting of the outer part and the inner part about a second joint axis in a second pivot plane.

Thus, the first joint axis can be perpendicular to the second joint axis or the first pivot plane can be perpendicular to the second pivot plane. In particular, the first joint and/or the second joint can only include a rotational degree of freedom about the first joint axis or about the second joint axis.

In order to implement this embodiment, the outer part can include two lobes that protrude in parallel from a base element wherein each of the lobes includes an inner spherical layer surface or spherical segment surface that envelop and contact diametrically opposed outer spherical layer surfaces or spherical segment surfaces at the inner part, so that the first pivot plane runs parallel to the two lobes and the first joint axis runs orthogonal to the two lobes.

Due to the mutual engagement of the inner spherical layer or spherical segment surfaces at both lobes and the outer spherical layer or spherical segment surfaces at the inner part, advantageously identical retaining forces of the form locking connection are provided independently from the pivot position of the lobes or the outer component with reference to the inner component.

The second joint axis can also be coaxial with respect to the center axis of the inner part or with respect to a center axis of the anchoring element.

Thus, it is an advantage of this embodiment that establishing the defined relative pivot position between the outer part and the inner part, and thus of the intended assembly or disassembly direction between the carrier element and the anchoring element only requires

a) interlocking the outer part with the inner part by positive form locking, and thereafter

b) aligning the outer part and the inner part about the second joint axis and in the second pivot plane by a defined pivot angle β₀ relative to each other so that the first pivot plane is parallel to the intended or predetermined mounting and/or dismounting direction, e.g. by rotating the outer part about a center axis of the inner part and by adjusting a defined pivot angle α₀ within the first pivot plane and about the first joint axis between the center axis of the outer part and the center axis of the inner part.

Thereafter, e.g. only the outer part and/or the inner part has to be attached at or in the carrier element or at or in the anchoring element. The embodiment described supra therefore assures very simple assembly/disassembly of carrier element and anchoring element in an intended assembly-/disassembly direction.

When the outer part is attached in or at the carrier element or at the anchoring element in the defined relative pivot position the defined orientation of the outer part relative to the inner part is maintained this way during assembly-/disassembly.

In particular the anchoring element can include an abutment and/or an implant. The carrier element can also be formed by a carrier sleeve for the dental prosthesis. Thus, it is irrelevant in which plane the separation between the anchoring element and the removable carrier element of the dental anchoring system occurs. The separation is also possible e.g. between the abutment configured as the anchoring element and e.g. a carrier sleeve for the dental prosthesis configured as the carrier element and/or between an implant configured as the anchoring element in an abutment configured as the carrier element.

The abutment is generally defined as a connecting part, meso structure between the implant and the prosthesis, thus the visible dental crown. The abutment can thus be attached as a separate part e.g. by a bolt at the implant or the abutment is integrally configured in one piece with the implant.

The implant is the structural support post of the dental implant system which includes e.g. an outer thread by which the implant is threaded into the jaw bone. Therefore, the implant is inserted into the jaw bone with an insertion section wherein a coronal end of the implant protrudes from the jaw bone wherein the abutment is attached by the bolt at the coronal end or wherein the abutment is configured at the coronal end.

Particularly advantageously the receiving section of the anchoring element and the support section of the carrier element are formed by complementary cone surfaces. This provides a centering of the carrier element on the anchoring element. The complementary cone surfaces are advantageously axially arranged so that they engage and contact each other and/or so that the carrier element and the anchoring element contact at associated axial stops at the carrier element and at the anchoring element when the disengage able form locking connection between the outer part and the inner part has been established in parallel.

The cone of the anchoring element advantageously tapers in the coronal direction viewed from the anchoring element so that an angled or slanted pulling of the carrier element from the anchoring element with respect to the center axis of the anchoring element is possible in the pull off direction which is defined e.g. by the alignment of the inner part or the outer part using the alignment element described supra.

Furthermore, the carrier element can include a central pass-through opening with an opening edge configured to lock and secure a bolt head of the fastening bolt and configured to pass a shaft of the fastening bolt through.

A second aspect of the invention relates to a dental anchoring system configured to anchor a carrier element at an anchoring element including at least the carrier element and the anchoring element,

a) wherein the carrier element is configured to be directly or indirectly attached at a dental super structure element, in particular a dental prosthesis, and

b) wherein the carrier element is disengageably attachable at the anchoring element by a disengageable positive form locking connection between an outer part and an inner part that is disengageable without destroying the outer part or the inner part so that the inner part is interlockable in the outer part by a press button- or interlocking connection that elastically deforms the inner part and/or the outer part

b1) wherein the outer part is provided at the anchoring element and the inner part is provided at the carrier element, or

b2) wherein the inner part is provided at the anchoring element and the outer part is provided at the carrier element, and

c) wherein the outer part and/or the inner part are separate components,

d) wherein the outer part is configured at least partially spherical and the inner part is configured at least partially complementary spherical so that the outer part and the inner part by themselves are pivotable into a plurality of relative pivot positions when the inner part is interlocked in the outer part,

f) wherein a defined relative pivot position is provided among the plurality of relative pivot positions where a center axis of the inner part and a center axis of the outer part are arranged non-coaxial and where an orientation of the center axis of the outer part and/or an orientation of the center axis of the inner part corresponds to an assembly or disassembly direction of the carrier element with reference to the anchoring element and where the carrier element and the anchoring element are able to be assembled or disassembled, and

g1) wherein the outer part is attached at the anchoring element or at the carrier element in the defined relative pivot position, or

g2) wherein the inner part is attached at the anchoring element or at the carrier element in the defined pivot position.

In the defined relative pivot position the center axis of the outer part and the center axis of the inner part can be coaxial or also non-coaxial.

According to an advantageous embodiment the outer part and the inner part can form a double joint or components of a double joint so that

a) a first joint of the double joint facilitates a relative pivoting of the outer part and the inner part about a first joint axis in a first pivot plane, and

b) a second joint of the double joint facilitates a relative pivoting of the outer part and the inner part about a second joint axis in a second pivot plane.

Thus, the first joint axis can be perpendicular to the second joint axis or the first pivot plane can be perpendicular to the second pivot plane. In particular, only a first degree of freedom of rotation can be provided in the first joint about the first joint axis and/or only a second degree of freedom can be provided in the second joint about the second joint axis.

In order to implement this embodiment, the outer part can have two lobes that protrude in parallel from a base element and that respectively include inner spherical layer surfaces or spherical segment surfaces which contact and envelop diametrically opposed outer spherical layer or spherical segment surfaces at the inner part so that the first pivot plane runs parallel to the two lobes and the first joint axis runs parallel to the two lobes.

Due to the mutual engagement of the inner spherical layer or spherical segment surfaces at the two lobes and the outer spherical layer or spherical segment surfaces at the inner part and the resultant circles at edges of the contacting surface sections of the outer spherical layer or spherical segment surfaces and the inner spherical layer or spherical segment surfaces identical retaining forces of the form locking connection are advantageously provided independently from the pivot position of the lobes or of the outer part with reference to the inner part.

The second joint axis can be coaxial with reference to the center axis of the inner part or with reference to a center axis of the anchoring element.

Advantageously establishing a defined relative pivot position between the outer part and the inner part and thus the intended assembly and/or disassembly direction between the carrier element and the anchoring element only requires

a) interlocking the outer part with the inner part by positive form locking and thereafter

b) aligning the outer part and the inner part about the second joint axis and in the second pivot plane about a defined pivot angle β₀ so that the first pivot plane is parallel to the intended assembly and/or the disassembly direction e.g. by rotating the outer part about the center axis of the inner part and adjusting a defined pivot angle α₀ between the center axis of the outer part and the center axis of the inner part within the first pivot plane about the first joint axis.

Thereafter only the outer part and/or the inner part have to be attached at or in the carrier element or at or in the anchoring element. The embodiment described supra therefore facilitates very simple assembly/disassembly between the carrier element and the anchoring element in a desired assembly-/disassembly direction.

When the outer part is e.g. attached in or at the carrier element or at the anchoring element in the defined relative pivot position, the defined relative orientation of the outer part relative to the inner part is maintained during assembly or disassembly.

Thus, the carrier element can be disassembled from the anchoring element or the carrier element can be mounted at the anchoring element without binding which facilitates handling and cleaning the dental prosthesis by the patient or by health care personnel.

### BRIEF DESCRIPTION OF THE DRAWINGS

The invention is subsequently described based on advantageous embodiments with reference to drawing figures, wherein

FIG. 1 illustrates a cross sectional view of a dental anchoring system with a first anchoring type according to an advantageous embodiment of the invention in an assembled condition of a carrier element at an anchoring element by an fastening bolt threaded into a threaded bore hole of the anchoring element;

FIG. 2 illustrates a cross sectional view of the dental anchoring system of FIG. 1 during disassembly of the carrier element from the anchoring element by removing the fastening bolt and pulling the carrier element from the anchoring element;

FIG. 3 illustrates a cross sectional view of the dental anchoring system of FIG. 1 where a bolt is threaded into the threaded bore hole of the anchoring element instead of the fastening bolt wherein an inner part of a disengageable positive form locking connection between the outer part and the inner part is configured at the bolt;

FIG. 4 illustrates a cross sectional view of the dental anchoring system of FIG. 1 where the outer part of the disengageable form locking connection is placed on the inner part and aligned therewith.

FIG. 5 illustrates a cross sectional view of the dental anchoring system of FIG. 1 where the carrier element has been placed on the outer part of the disengageable form locking connection which implements a second anchoring type of the dental anchoring system;

FIG. 6 illustrates a cross sectional view of a dental anchoring system according to another embodiment of the invention where the inner part of the disengage able form locking connection is already integrally formed at the anchoring element when using the second anchoring type;

FIG. 7 illustrates a cross sectional view of the dental anchoring system of FIG. 6 where the outer part and the carrier element are mounted on the inner part;

FIG. 8 illustrates a cross sectional view of the dental anchoring system using the second anchoring type according to another embodiment of the invention;

FIG. 9 illustrates a cross sectional view along the line B-B of the dental anchoring system according to FIG. 8;

FIG. 10 illustrates cross sectional view of the dental anchoring system according to FIG. 8 that is rotated by 90 degrees relative to the cross sectional view of FIG. 9;

FIG. 11 illustrates a cross sectional view along the line C-C of the dental anchoring system according to FIG. 10;

FIG. 12 illustrates an isometric view of the dental anchoring system of according to FIG. 11.

### DETAILED DESCRIPTION OF THE INVENTION

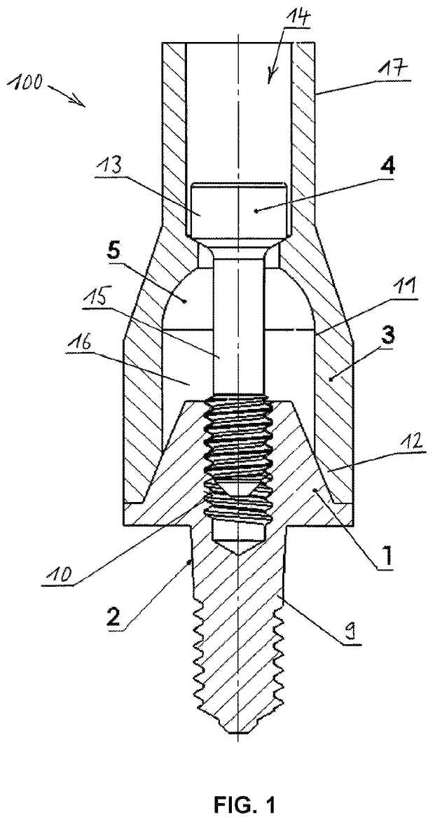

FIG. 1 illustrates a cross sectional view of a dental anchoring system using a first anchoring type 100 according to an advantageous embodiment of the invention in an assembled condition of a carrier element 3 at an anchoring element 9 using an fastening bolt 4 that is threaded into a threaded bore hole 10 of the anchoring element 9.

The anchoring element 9, thus e.g. an abutment includes an anchoring section 2 including e.g. an external thread configured to be anchored in an inner thread of an implant and a receiving section 1 configured e.g. as an exterior cone that tapers in a coronal direction and that is configured to receive the carrier element 3 and the central threaded bore hole 10. The carrier element 3 which is configured herein, e.g. as a sleeve in particular made from titanium or a titanium alloy is configured at its outer surface 17 for direct or indirect attachment at a dental super structure element in particular a dental prosthesis. Alternatively the carrier element 3 can also be formed by an abutment or can include the abutment wherein the anchoring element 9 is then formed by an implant.

A support section 12 is formed at an inner surface 11 of the carrier element 3 and also configured as an inner cone that also tapers in the coronal direction configured to be supported at the receiving section 1 of the anchoring element 9 and an apically open cavity 5 is arranged axially adjacent thereto. In the dental anchoring system using the first anchoring type 100 illustrated herein a bolt head 13 of the fastening bolt 4 is locked at an edge of a central pass through bore hole 14 of the carrier element 3 and a shaft 15 of the fastening bolt 4 extends coaxially through the cavity 5 into the threaded bore hole 10 in the anchoring element 2. The receiving section (outer cone 1) of the anchoring element 9 and the shaft 15 of the fastening bolt 4 protrudes into the cavity 5 in an assembled condition of the dental anchoring system using the first anchoring type 100.

The cavity 5 of the carrier element 3, however, is configured larger than required for the protrusion of the receiving section (outer cone 1) of the anchoring element 9 and of the shaft 15 of the fastening bolt 4 for as evident from FIG. 1. Thus, the cavity 5 forms an open annular cavity 16 in the illustrated dental anchoring system in the first anchoring type 100 wherein the annular cavity is defined by the radially outer circumferential surface 15 of the fastening bolt 4, the receiving section (outer cone) 1 of the anchoring element 9 and the inner surface of the carrier element 3.

In the dental anchoring system using the first anchoring type 100 the carrier element 3 is attached at the anchoring element 9 using the fastening bolt 4 by clamping the conical support section 12 of the carrier element 3 against the complementary conical receiving section 1 of the anchoring element 9 by the threaded fastening bolt 4, that extends through the cavity 5 with its shaft 15 and that is threaded into the threaded bore hole 10 of the anchoring element 9. Additionally the sleeve shaped carrier element 3 contacts a rim of the anchoring element configured as a stop with an apical end of the carrier element 3 configured as a cylindrical sleeve edge in an assembled condition of the dental anchoring system using the first anchoring type 100 as illustrated in FIG. 1.

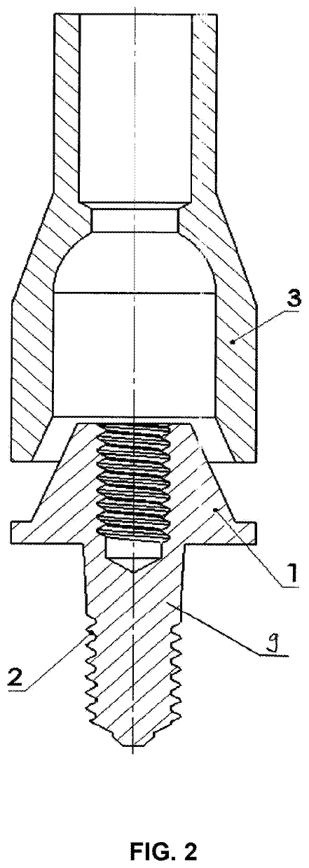

FIG. 2 illustrates a cross sectional view of the dental anchoring system in the first anchoring type according to FIG. 1 during disassembly of the carrier element 3 from the anchoring element 9 after removing the fastening bolt 4 and axially pulling the carrier element 3 from the anchoring element 9. Thus, the conical support section 12 of the carrier element 3 and the conical receiving section 1 of the anchoring element 9 move out of engagement.

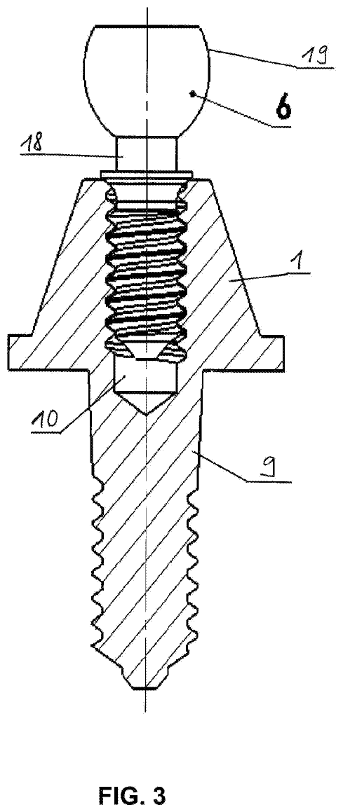

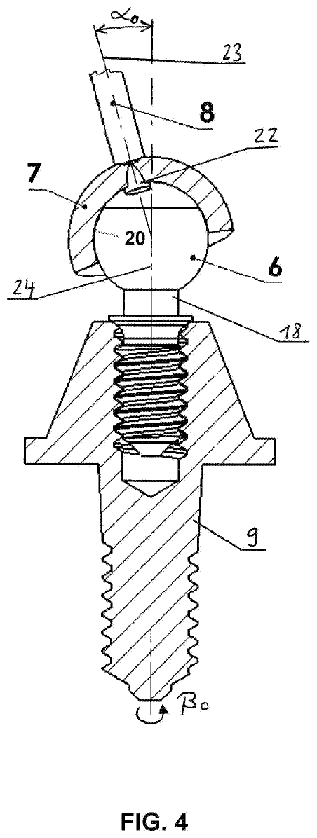

FIG. 3 illustrates a cross sectional view of the dental anchoring system in the first anchoring type according to FIG. 1 where a bolt 18 is threaded into the threaded bore hole 10 of the anchoring element 9 instead of the fastening bolt 4 wherein an inner portion of a disengageable form locking connection is configured at a top of the bolt integrally in one piece between the outer part 7 and the inner part 6 illustrated in FIG. 4. The inner part 6 is thus configured e.g. as a bolt head of the bolt 18 at a coronal end of the bolt head.

The inner part 6 like the bolt 18 is made e.g. from a rather stiff material like metal whereas the outer part 7 is configured e.g. cap shaped and made from a comparatively elastic synthetic material. The inner part 6 includes e.g. an outer spherical layer surface 19 and the outer part 7 includes an inner spherical layer surface 20 that is complementary to the outer spherical layer surface 19 so that the inner part 6 is pressable or interlockable in the outer part 7 using a press button or inter locking connection elastically deforming the outer part 7 so that the connection is configured as a ball joint where the outer part 7 and the inner part 6 are freely pivotable relative to each other in all rotational degrees of freedom as illustrated in FIG. 4. Thus, the cap shaped outer part 7 has a cross section that is undercut with respect to the cross section of the inner part 6 so that the locking or unlocking of the press button or interlocking connection is enabled by the elastic deformation of the outer part 7.

The dental anchoring system furthermore includes an alignment element 8 thus configured e.g. as an alignment rod, whose end is engageable at an engagement section 22 of the outer part 7 in order to pivot or align the outer part about a center axis of the cap shaped outer part 7 relative to the center axis 24 of the inner part 6 by a defined pivot angle α₀.

Due to the spherical and circumferential outer and inner spherical layer surfaces 19, 20 at the outer part 7 and the inner part 6, a pivoting of the center axis 23 of the outer part 7 relative to the center axis 24 of the inner part 6 is possible in all directions and in particular in all planes. Consequently, the outer part 7 can be pivoted additionally by the alignment element 8 about the center axis 24 of the inner part 6 or about the center axis of the anchoring element 9 about a defined pivot angle β₀. The center axis 24 of the inner part 7 is e.g. coaxial to the center axis of the anchoring element 9.

The defined pivot angle α₀ and the defined pivot angle β₀ designate a defined relative pivot position α₀, Po between the outer part 7 and the inner part 6 in which e.g. the center axis 23 of the outer part 7 has an orientation which corresponds to a pull off direction of the carrier element 3 from the anchoring element 2 when disengaging the press button or interlocking connection. Vice versa, the defined relative pivot position α₀, β₀ represents a mounting direction between the carrier element 3 and the anchoring element 9 when assembling the press button or interlocking connection. In the defined relative pivot position α₀, β₀ in particular the center axis 23 of the outer part 7 and the center axis 24 of the inner part 6 can be non-coaxial.

A pivoting of the center axis 23 of the outer part 7 relative to the center axis 24 of the inner part 6 into the defined relative pivot position, α₀, β₀, can be required when the dental prosthesis includes plural implants which have not been implanted in parallel with one another, so that the wedging among the implants and damages to the outer part and/or the inner part would otherwise be created when pulling the carrier element 3 from the anchoring element 9.

According to another embodiment, an alignment element can be omitted and the defined relative pivot position α₀, Po between the outer part 7 and the inner part 6 can be established by manual engagement.

FIG. 4 shows the condition of the dental anchoring system where the outer part 7 is placed on the inner part 6 under external force impact and elastic deformation of the outer part 7 and aligned according to the defined relative pivot position α₀, Po by the alignment element 8. The mounting and dismounting direction or pull off direction defined by the center axis 23 of the aligned outer part 7 can thus have a pivot angle α₀ with respect to the center axis 24 of the inner part 6 that differs from 0 as evident in particular from FIG. 4.

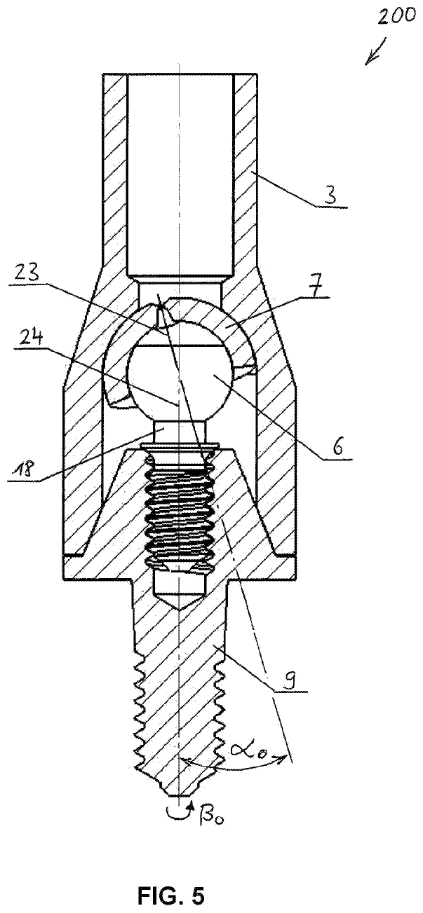

FIG. 5 shows a cross sectional view of the dental anchoring system of FIG. 1 where the carrier element 3 has been placed onto the outer part 7 that is oriented in the defined relative pivot position α₀, β₀ which implements the dental anchoring system in a second anchoring type 200. For example the inner surface 11, or the cavity 5 includes a rounded circular segment shape 25 at its coronal end wherein the circular segment shape 25 is configured complementary to the outer radius of the cap shaped outer part 7 so that the outer part 7 can be arranged and attached in the rounded shape 25 of the carrier element 3. The connection between the outer part 7 and the inner surface 11 of the carrier element in the cavity 5 can be obtained e.g. by bonding or gluing. Instead, a connection that is disengageable without destruction can also be provided between the outer part 7 and the carrier element 3.

In the second anchoring type 200 of the dental anchoring system, the carrier element 3 can be pulled off together with the dental prosthesis supported thereon and the outer part 7 in the pull off direction from the anchoring element 9 and in particular from the inner part that remains thereon by disengaging the press button or interlocking connection e.g. by the patient in order to perform a cleaning of the dental prosthesis. The press button or interlocking connection of the inner part 6 and the outer part 7 is then disengaged without destruction because the outer part 7 made from elastic synthetic material can elastically deform when the inner part 6 unlocks.

Therefore the dental anchoring system is reconfigurable from the first anchoring type 100 according to FIG. 1 to the second anchoring type 200 according to FIG. 5 in particular by disengaging the fastening bolt 4, pulling the carrier element 3 from the anchoring element 9 and arranging the inner part 6 at the anchoring element 9 or connecting it therewith, interlocking the outer part 7 with the inner part 6 and aligning the outer part according to a predetermined pull off direction and then arranging or connecting the carrier element at the outer part 7.

Furthermore the dental anchoring system is reconfigurable from the second anchoring type 200 according to FIG. 5 to the first anchoring type 100 according to FIG. 1 in particular in that the carrier element 3 is pulled from the anchoring element 9 in the pull off direction, the outer part 7 is removed from the carrier element 3 and the bolt 18 with the inner part 6 is removed from the anchoring element 9 and then the carrier element 3 is axially joined again with the anchoring element 9 and the fastening bolt 4 is run through the pass through bore hole in the carrier element 3 and threaded into the threaded bore hole 10 of the anchoring element 9. This is done easily since the threaded bore hole 10 is still provided in the anchoring element 9.

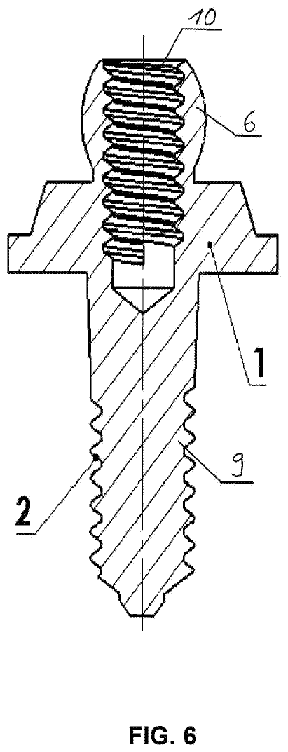

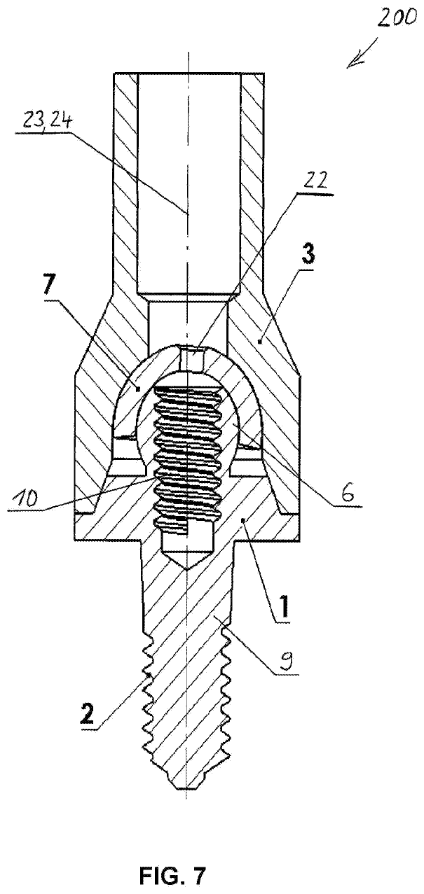

FIGS. 6 and 7 respectively show a cross sectional view of a dental anchoring system using the second anchoring type according to another advantageous embodiment of the invention where the inner part 6 of the disengageable form locking connection is integrally formed at the anchoring element 9 or its receiving section 1. Thus, the additional bolt 18 according to the embodiment of FIGS. 3-5, can be omitted. The threaded bore hole 10 for the fastening bolt 4 then protrudes centrally through the inner part 6 as illustrated in FIG. 6.

FIG. 7 shows the dental anchoring system using the second anchoring type 200 in assembled condition, this means with the outer part 7 and the carrier element 3 mounted to the inner part 6. The reconfiguration from the first anchoring type to the second anchoring type and vice versa is then performed as described in the embodiments according to FIGS. 1-5. The only difference being that the inner part is not arranged at the anchoring element 9 nor has to be removed therefrom.

Furthermore, the center axes 23, 24 of the outer part 7 and of the inner part 6 are e.g. parallel to one another so that the outer part 7 is oriented into this position by the alignment element 8 relative to the inner part 6 or the outer part 7 is placed on the inner part 6 right from the beginning.

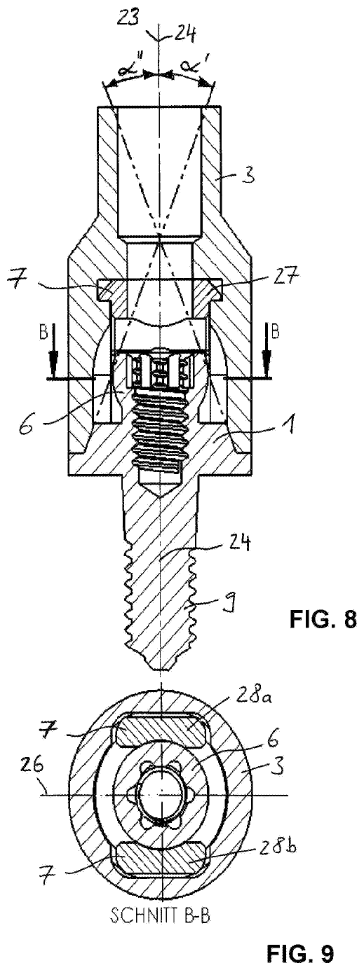

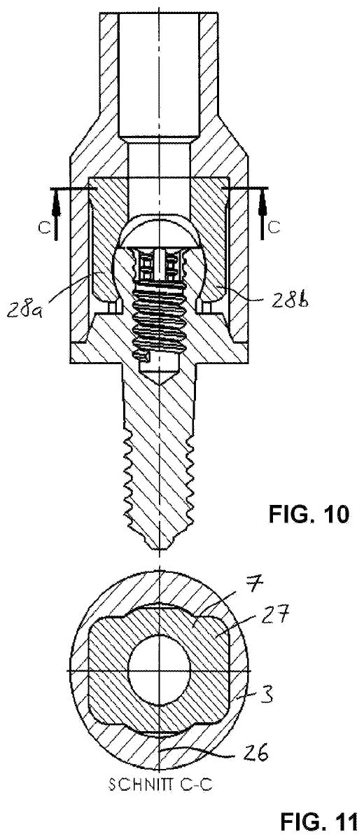

FIG. 8 is a cross sectional view of a dental anchoring system using the second anchoring type 200 according to another advantageous embodiment of the invention. FIG. 9 illustrates a cross sectional view of the line B-B of the dental anchoring system according to FIG. 8. FIG. 10 illustrates a cross sectional view of the dental anchoring system of FIG. 8 that is rotated by 90 degrees relative to the cross sectional view of FIG. 9. FIG. 11 illustrates a cross sectional view along the line C-C of the dental anchoring system of FIG. 10. The inner part 6 is integrally configured in one piece with the anchoring element 9 like in the embodiment of FIGS. 6 and 7. Furthermore, also the center axis 24 of the inner part 6 is configured e.g. coaxial of the center axis of the anchoring element 9.

In this additional embodiment the outer part 7 and the inner part 6 can form a double joint.

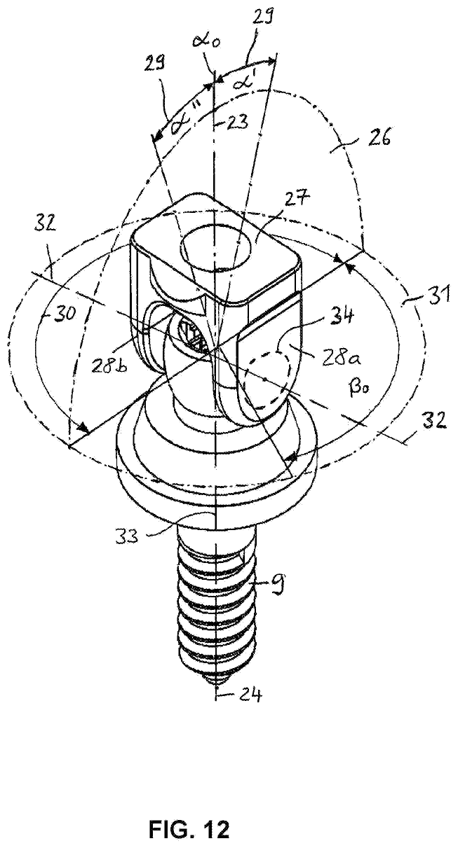

A first joint of the double joint can perform the pivoting indicated in FIG. 12 by a first arrow 29 between the outer part 7 and the inner part 6 by changing the pivot angle α between the center axis 23 of the outer part 7 and the center axis 24 of the inner part 6 advantageously about a first joint axis 32 and in a first pivot plane 26 and in both rotation directions within this first pivot plane 26. Then a defined pivot angle α₀ can be adjusted between the center axis 23 of the outer part 7 and the center axis 24 of the inner part 6 like in the embodiment described supra, wherein the pivot angle characterizes a desired or predetermined assembly or disassembly direction of the carrier element 3 relative to the anchoring element 9 within the first pivot plane 26. The first pivot plane 26 is in particular parallel to the center axis 24 of the inner part 6 or parallel to the center axis of the anchoring element 9. Furthermore, the first joint axis 32 is perpendicular to the center axis 24 of the inner part 6.

The first pivot plane 26 can be aligned by a rotation between the outer part already connected with the inner part by positive form locking and the inner part 6 in particular about the center axis 24 of the inner part 6 or the center axis of the anchoring element 9 about a second joint axis 33 of a second joint of the double joint in a second pivot plane 31 by a defined pivot angle β₀ so that the first pivot plane 26 is parallel to the desired or predetermined assembly or disassembly direction of the carrier element 3 relative to the anchoring element 9. In particular the second joint axis 33 of the second joint is coaxial with the center axis 24 of the inner part 6 or with the center axis of the anchoring element 9.

Thus, a pivoting of the outer part 7 about the center axis 24 of the inner part 6 by the pivot angle β is possible up to 180° degrees in both directions in the second pivot plane 31 as indicated by the second arrow 30 in FIG. 12. The second pivot plane 31 is in particular perpendicular to the center axis 24 of the inner part 6 and/or to the center axis of the anchoring element 9. Furthermore, the second joint axis 33 of the second joint is perpendicular to the first joint axis 32 of the first joint.

The pivot angle α between the center axis 23 of the outer part 7 and the center axis 24 of the inner part 6 does not change during the rotation along the second arrow 30 that indicates the two possible directions of rotation in the second pivot plane 31 in FIG. 12. In particular the first pivot axis 26 is perpendicular to the second pivot plane 31.

In the embodiment shown in FIGS. 8-12, the defined pivot angle α₀ between the center axis 24 of the outer part 7 and the center axis 24 of the inner part 6 is e.g. equal to zero degrees, however it can differ from zero and can be in particular in a range between two limit pivot angles α′ and α″ which are different from zero.

The defined pivot angle α₀ and the pivot angle β₀ therefore characterize a defined relative pivot position α₀, β₀ of the outer part 7 and the inner part 6 relative to each other which represents an intended or predetermined mounting or dismounting direction of the carrier element 3 relative to the anchoring element 9. In the defined relative pivot position α₀, β₀ in particular the center axis 23 of the outer part 7 and the center axis 24 of the inner part 6 can be non-coaxial.

In order to implement the kinematics described supra with the first pivot plane 26 and the second pivot plane 31, the outer part 7 can include two lobes 28a, 28b respectively protruding in parallel with each other from a base element 27 and respectively including spherical layer or spherical segment surfaces 20 which contact and envelop diametrically opposed spherical layer or spherical segment surfaces 19 at the inner part 6 so that the first pivot axis 26 runs parallel to both lobes 28a, 28b as evident in particular from FIG. 9. This defines the first pivot plane 26 which is parallel to the lobes 28a, 28b.

Advantageously it is only possible within this first pivot plane 26 to pivot the center axis 23 of the outer part 7 relative to the center axis 24 of the inner part 6 and thus change the pivot angle α in the illustrated embodiment e.g. by 22° at the most in both directions. Then the center axis 23 of the outer part 7 can assume the two limit pivot angles α′ and a″ relative to the center axis 24 of the inner part or relative to the center axis of the anchoring element 9 indicated in FIG. 12. The limit pivot angles α′ and a″ of the outer part 7 relative to the inner part 6 within the first pivot plane 26 are defined herein e.g. by the cone angle of the cone surface of the receiving section 1 of the anchoring element 9.

It is an advantage of this embodiment that only the outer part 7 is positively form locked with the inner part 6 in order to establish the defined pivot position α₀ and β₀ between the outer part 7 and the inner part 6 or a predetermined mounting or dismounting direction between the carrier element 3 and the anchoring element 9 e.g. by axially placing the outer part 7 onto the inner part 6 while elastically deforming the lobes 28a, 28b and establishing the disengageable form locking and pivotable connection between the outer part 7 and the inner part 6 through an elastic spring back effect of the two lobes 28a, 28b. Then the outer part 7 is rotated relative to the center axis 24 of the inner part 6 or relative to the center axis of the anchoring element 9 about the second joint axis 33 in the second pivot plane 31 in directions indicated in FIG. 12 by the second arrow 30 so that the defined pivot angle β₀ is adjusted in the first pivot plane 26 defined e.g. by the lobes 28a, 28b of the outer part 7. Then the outer part 7 is rotated relative to the inner part 6 about the first joint axis 32 and within the first pivot plane 26 in one of the directions indicated by the first arrow 29 in FIG. 12, so that the center axis 23 of the outer part 7 assumes the defined pivot angle α₀ with respect to the center axis 24 of the inner part 6 within the first pivot plane 26.

The sequence of the pivoting about the first joint axis 32 and the second joint axis 33 is not imperative, this means it is also possible to initially pivot about the first joint axis 32 and thereafter about the second joint axis 33 or vice versa.

Due to the mutual engagement of the inner spherical layer surfaces or spherical segment surfaces 20 at both lobes 28a, 28b and the outer spherical layer or spherical segment surfaces 19 at the inner part 6 circles 34 shown in FIG. 12 by a dashed line designate edges of contacting surface sections of the outer spherical layer or spherical segment surfaces 19 and the inner spherical layer or spherical segment surfaces 20. Then, identical retaining forces of the positively form locking or press button connection are advantageously provided irrespective of a pivot position of the lobes 28a, 28b or of the outer part about the first pivot axis 32 relative to the inner part 6.

As evident from FIG. 12, a pivoting of the outer part 7 in an imaginary pivot plane that includes the first joint axis 32 is not possible due to the geometric conditions (outer spherical layer surfaces or spherical segment surfaces 19 and inner spherical layer or spherical segment surfaces 20) between the lobes 28a, 28b and the inner part 6. Rather the first joint only includes a first rotational degree of freedom about the first joint axis 32 and the second joint only includes a second rotational degree of freedom about the second joint axis 33. This has the advantage that aligning the presumed initially mobile outer part 7 relative to the presumed stationery inner part 6 can only be performed about two joint axes 32, 33 without allowing an uncontrolled tilting of the outer part 7 relative to the inner part 6 when any rotational degree of freedom about any rotation axis is enabled like in a ball joint.

Thereafter, only e.g. the carrier element 3 has to be attached at the outer part 7 that is pivoted into the defined pivot position α₀, β₀, in particular by gluing. Since the inner part 6 is fixed at the anchoring element 9 and the outer part 7 is fixed at the carrier element, respectively in a defined position, this defined position is also maintained during an assembly or disassembly of the carrier element 3 and the anchoring element 9. The defined pivot position α₀, β₀ between the outer part 7 and the inner part 6 represents a defined or predetermined mounting or dismounting direction of the carrier element 3 relative to the anchoring element 9 in order to mount e.g. the dental anchoring system in the second anchoring type 200. During assembly the carrier element 3 is placed onto the anchoring element 9 in the mounting direction predetermined by the defined pivot position α₀, β₀ which brings the inner part 6 into form locking engagement with the outer part 7 by elastically deforming the two lobes 28a, 28b and then moving back spring elastic towards the inner part 6.

Vice versa, only the carrier element 3 is pulled off from the anchoring element 9 in the dismounting direction predetermined by the defined pivot position α₀, β₀ in order to dismount the dental anchoring system in the second anchoring type 200, wherein the inner part 6 moves out of engagement with the outer part 7 by elastically deforming the two lobes 28a, 28b which spring back thereafter.

### REFERENCE NUMERALS AND DESIGNATIONS

1 receiving section
2 anchoring section
3 carrier element
4 fastening bolt
5 cavity
6 inner part
7 outer part
8 alignment element
9 anchoring element
10 threaded bore hole
11 inner surface
12 support section
13 bolt head
14 pass through bore hole
15 shaft
16 annular cavity
17 outer surface
18 bolt
19 outer spherical layer surface
20 inner spherical layer surface
22 engagement section
23 pull off direction/center axis of outer part
24 center axis of inner part
25 rounded transition surface
26 first pivot plane
27 base element
28a lobe
28b lobe
29 first arrow
30 second arrow
31 second pivot plane
32 first joint axis
33 second joint axis
34 circle
100 dental anchoring system in the first anchoring type
200 dental anchoring system in the second anchoring type
α pivot angle
α′ α″ limit pivot angle
β pivot angle
α₀ defined pivot angle
β₀ defined pivot angle
α₀, β₀ defined pivot position

What is claimed is:

1. A dental anchoring system configured to anchor a carrier element at an anchoring element, the dental anchoring system comprising:
the carrier element;
the anchoring element; and
a fastening bolt,
wherein the anchoring element includes a receiving section configured to receive the carrier element and a threaded bore,
wherein the carrier element is configured to directly or indirectly attach a dental superstructure element or a dental prosthesis and wherein the carrier element includes a support section configured to be supported at the receiving section of the anchoring element,
wherein the carrier element is attachable at the anchoring element by a first anchoring type using the fastening bolt by receiving the support section of the carrier element at the receiving section of the anchoring element and threading the fastening bolt into the threaded bore of the anchoring element,
wherein the carrier element is attachable at the anchoring element in a disengageable manner optionally also by a second anchoring type without using the fastening bolt by providing a positive form locking connection between an outer part and an inner part that is disengageable without destruction wherein the inner part is interlockable in the outer part by a press button or interlocking connection elastically deforming the inner part or the outer part,
wherein the outer part is provided at the anchoring element and the inner part is provided at the carrier element, or
wherein the inner part is provided at the anchoring element and the outer part is provided at the carrier element,
wherein the carrier element is received with the support section at the receiving section of the anchoring element by positive interlocking of the inner part in the outer part without destruction so that the carrier element is removably supported at the anchoring element, and
wherein the carrier element is pullable from the anchoring element by unlocking the inner part from the outer part without destruction when disengaging the second anchoring type.

2. The dental anchoring system according to claim 1, wherein the dental anchoring system is reconfigurable from the second anchoring type to the first anchoring type by pulling the carrier element from the anchoring element, in particular by removing the inner part or the outer part and then receiving the carrier element with its support section at the receiving section of the anchoring element and threading the fastening bolt into the threaded bore of the anchoring element.

3. The dental anchoring system according to claim 1,
wherein the carrier element forms an apically open cavity with an inner surface of the carrier element, and
wherein the apically open cavity is configured to receive an arrangement of the inner part or the outer part in the cavity, or
wherein the inner part or the outer part is arranged in the cavity already from the beginning so that a shaft of the fastening bolt is at least partially insertable through the apically open cavity.

4. The dental anchoring system according to claim 1, wherein the inner part or the outer part is formed at a coronal end of a second bolt which is threadable with an apical end into the threaded bore hole of the anchoring element instead of the fastening bolt when using the second anchoring type.

5. The dental anchoring system according to claim 1,
wherein the inner part and the outer part are separate parts that are attachable at the carrier element and at the anchoring element, or
wherein the inner part is integrally configured in one piece at the anchoring element or the carrier element or the outer part is integrally configured in one piece at the anchoring element or the carrier element.

6. The dental anchoring system according to claim 1, wherein the outer part is configured at least partially spherical and the inner part is configured at least partially complementary spherical so that the outer part and the inner part by themselves are respectively pivotable into a plurality of pivot positions relative to each other when the outer part is interlocked in the inner part.

7. The dental anchoring system according to claim 6,
wherein the inner part includes an outer spherical layer or spherical segment surface and the outer part includes an inner spherical layer or spherical segment surface that is complementary to the outer spherical layer of spherical segment surface, and
wherein the inner spherical layer or spherical segment surface and the outer spherical layer or spherical segment surface contact each other.

8. The dental anchoring system according claim 6, wherein a defined relative pivot position is provided where an orientation of a center axis of the outer part or an orientation of a center axis of the inner part corresponds to a mounting or dismounting direction of the carrier element with reference to the anchoring element where the carrier element and the anchoring element are mountable at each other and dismountable from each other.

9. The dental anchoring system according to claim 8, further comprising:
at least one alignment element,
wherein the outer part or the inner part includes an engagement section configured to engage the at least one alignment element,
wherein the outer part and the inner part are movable into the defined relative pivot position through an engagement of the at least one alignment element at the engagement section and by a subsequent movement of the at least one alignment element.

10. The dental anchoring system according to claim 8,
wherein the outer part and the inner part jointly form a double joint,
wherein a first joint of the double joint enables a relative pivoting of the outer part and the inner part about a first joint axis in a first pivot plane, and
wherein the second joint of the double joint enables a relative pivoting of the outer part and the inner part about a second joint axis in a second pivot plane.

11. The dental anchoring system according to claim 10, wherein the first joint axis is perpendicular to the second joint axis.

12. The dental anchoring system according to claim 10,
wherein the outer part includes two lobes protruding in parallel from a base element and respectively including inner spherical layer surfaces or spherical segment surfaces which contact and envelop diametrically opposed outer spherical layer or spherical segment surfaces at the inner part so that the first pivot plan extends parallel to the two lobes and the first joint axis extends perpendicular to the two lobes.

13. The dental anchoring system according to claim 10, wherein the second joint axis is coaxial to the center axis of the inner part or to a center axis of the anchoring element.

14. The dental anchoring system according to claim 8,
wherein the outer part is attached at the anchoring element or the carrier element in the defined relative pivot position, or
wherein the inner part is attached at the anchoring element or the carrier element in the defined relative pivot position.

15. The dental anchoring system according to claim 1, wherein the carrier element includes a central pass-through opening including an opening edge configured to lock a bolt head of the fastening bolt and to pass a shaft of the fastening bolt through.

16. The dental anchoring system according to claim 1, wherein the receiving section of the anchoring element and the support section of the carrier element are formed by complementary cone surfaces.

17. The dental anchoring system according to claim 1, wherein the anchoring element includes an implant or an abutment.

18. A dental anchoring system configured to anchor a carrier element at an anchoring element, the anchoring system comprising:
the carrier element and the anchoring element,
wherein the carrier element is configured directly or indirectly attachable at a dental super structure element or a dental prosthesis, and
wherein the carrier element is disengageably attachable at the anchoring element by a positive form locking connection between an outer part and an inner part that is disengageable without destroying the outer part or the inner part so that the inner part is interlockable in the outer part by a press button- or interlocking connection that elastically deforms the inner part or the outer part,
wherein the outer part is provided at the anchoring element and the inner part is provided at the carrier element, or
wherein the inner part is provided at the anchoring element and the outer part is provided at the carrier element, and
wherein the outer part or the inner part are separate components,
wherein the outer part is configured at least partially spherical and the inner part is configured at least partially complementary spherical so that the outer part and the inner part by themselves are pivotable into a plurality of relative pivot positions when the inner part is interlocked in the outer part,
wherein a defined relative pivot position is provided among the plurality of relative pivot positions where a center axis of the inner part and a center axis of the outer part are arranged non-coaxial and where an orientation of the center axis of the outer part or an orientation of the center axis of the inner part corresponds to an assembly or disassembly direction of the carrier element with reference to the anchoring element and where the carrier element and the anchoring element are able to be assembled or disassembled, and
wherein the outer part is attached at the anchoring element or the carrier element in the defined relative pivot position, or
wherein the inner part is attached at the anchoring element or the carrier element in the defined relative pivot position.

19. The dental anchoring system according to claim 18,
wherein the outer part and the inner part form a double joint in combination,
wherein a first joint of the double joint facilitates a relative pivoting of the outer part and the inner part about a first joint axis in a first pivot plane, and
wherein a second joint of the double joint facilitates a relative pivoting of the outer part and the inner part about a second joint axis in a second pivot plane.

20. The dental anchoring system according to claim 19, wherein the first joint axis extends perpendicular to the second joint axis.

21. The dental anchoring system according to claim 19,
wherein the outer part includes two lobes that protrude in parallel from a base element and that respectively include inner spherical layer surfaces or spherical segment surfaces which contact and envelop diametrically opposed outer spherical layer or spherical segment surfaces at the inner part so that the first pivot plane runs parallel to the two lobes and the first joint axis runs perpendicular to the two lobes.

22. The dental anchoring system according to claim 19, wherein the second joint axis is coaxial to the center axis of the inner part or to a center axis of the anchoring element.
